(19) United States
(12) Patent Application Publication
(10) Pub. No.: US 2021/0141366 A1
(43) Pub. Date: May 13, 2021

(54) FACTORY MANAGEMENT SYSTEM

(71) Applicant: JTEKT CORPORATION, Osaka-shi (JP)

(72) Inventors: Yuji YAMAGUCHI, Toyokawa-shi (JP); Yasuhiro KONDOU, Kiyosu-shi (JP); Kazunori AKIYAMA, Osaka-shi (JP)

(73) Assignee: JTEKT CORPORATION, Osaka-shi (JP)

(21) Appl. No.: 17/094,197

(22) Filed: Nov. 10, 2020

(30) Foreign Application Priority Data
Nov. 11, 2019 (JP) 2019-203847

(51) Int. Cl. G05B 19/418; G05B 19/048; G06Q 10/06; G06F 11/30

(52) U.S. Cl. CPC G05B 19/41875; G05B 19/41865; G06F 11/3075; G06Q 10/06311; G05B 19/048

(57) ABSTRACT

A factory management system has a database for managing a factory in which a production line is provided. The factory management system includes a communication unit, a collection and storage unit and a compilation and display unit. The communication unit connects production facilities of the production line with host systems such that the production facilities and the host systems communicate with each other. The collection and storage unit is one of the host systems and collects production status data on a production status from the production facilities via the communication unit and stores the production status data in the database. The compilation and display unit is provided separately from the collection and storage unit via a communication interface. The compilation and display unit compiles a predetermined data out of the production status data stored in the database and display the first predetermined data.

### CROSS-REFERENCE TO RELATED APPLICATION

The present application claims priority to Japanese Patent Application No. 2019-203847 filed on Nov. 11, 2019, the entire content of which is incorporated herein by reference.

### TECHNICAL FIELD

The present invention relates to a factory management system.

### BACKGROUND

A related-art factory management system collects data output from a programmable logic controller (hereinafter referred to as a PLC) provided in each production facility in a factory, stores the data in a database, specifies periods and conditions in the database, classifies and compiles the data according to the specified periods and conditions, and displays the classified data (see, for example, JP2019-36076A). In this factory management system, application programs (hereinafter abbreviated as applications) designed for various purposes, collect data, store the data in databases corresponding to the applications, and compile and display the data.

However, in the above-described related-art factory management system, the data is to be collected by each of the applications and stored in individual databases corresponding to the applications, and the data is compiled and displayed after being retrieved from each database. That means, a single or common database cannot be used among the plurality of applications, and it is often difficult to display the data in a manner that various needs for displaying data can be met.

### SUMMARY

Illustrative aspects of the present invention provide a factory management system configured to display data in various manners according to different purposes, by commonly using data output from a production facility.

A factory management system has a database for managing a factory in which a production line is provided. The factory management system includes a communication unit, a collection and storage unit and a compilation and display unit. The communication unit is configured to connect each of production facilities of the production line with host systems such that the production facilities and the host systems communicate with each other. The collection and storage unit is one of the host systems and is configured to collect production status data relating to a production status from each of the production facilities via the communication unit and store the production status data in the database. The compilation and display unit is provided separately from the collection and storage unit via a communication interface. The compilation and display unit is configured to compile a predetermined data out of the production status data stored in the database and display the first predetermined data.

According to this configuration, the production status data is collected from each production facility by the collection and storage unit via the communication unit, and is reliably stored in the database. Meanwhile, by the compilation and display unit provided separately from the collection and storage unit via the communication interface, any piece of data is compiled out of the production status data stored in the database for predetermined purposes and is displayed in various forms. Therefore, the data output from the production facility can be commonly used to execute various types of display according to the predetermined purposes.

Other aspects and advantages of the invention will be apparent from the following description, the drawings and the claims.

### BRIEF DESCRIPTION OF DRAWINGS

FIG. 1 is a block diagram showing an overall configuration of a factory management system according to an embodiment;

FIG. 2 shows an example of log data received by a communication server;

FIG. 3 shows a storage example of a time-specific table in a production line;

FIG. 4 shows a storage example of a stop time count table;

FIG. 5 shows a storage example of an abnormality history table;

FIG. 6 shows a display example of an industrial accident/traffic accident input screen;

FIG. 7 shows a storage example of an industrial accident management table;

FIG. 8 shows a storage example of a traffic accident management table;

FIG. 9 shows a display example of a quality problem input screen;

FIG. 10 shows a storage example of a quality problem management table;

FIG. 11 shows a display example of a 4M change input screen;

FIG. 12 shows a storage example of a change management table;

FIG. 13 shows a display example of a staffing input screen;

FIG. 14 shows a storage example of a staffing management table;

FIG. 15 shows a display example of a factory management home screen;

FIG. 16 shows a display example of an overall Pareto diagram showing the number of abnormalities in each production facility and individual Pareto diagrams on quality abnormalities and facility abnormalities;

FIG. 17 shows a display example of a graph showing a transition of cycle time and an abnormality occurrence time point;

FIG. 18 shows a display example of a production record management screen;

FIG. 19 shows a display example of a problem and abnormality treatment detail screen;

FIG. 20 shows a display example of a screen for compiled data on abnormality; and

FIG. 21 shows a display example of a breakdown graph for abnormality.

### DESCRIPTION OF EMBODIMENTS

A factory management system according to an embodiment will be described with reference to the drawings. First, an overall configuration of a factory management system 1 will be described with reference to FIG. 1. The factory management system 1 is configured to manage a factory in which a production line 10 is provided. The factory management system 1 includes PLCs, a communication server 30 as a collection and storage unit, a collection and storage device 34, an input and storage device 36, a database group 40, and a compilation and display device 50.

The production line 10 includes a plurality of processes for producing products such as automobile parts, and is formed by a plurality of production facilities 11 to 14 each corresponding to a respective one of the processes. Specifically, the production facilities 11 to 14 are, for example, a processing machine, an assembly machine such as a machine tool or a robot, or an inspection device. The production facility 11 corresponds to a first process machine, the production facility 12 corresponds to a second process machine, the production facility 13 corresponds to a third process assembly machine, and the production facility 14 corresponds to a fourth process inspection machine. Products are manufactured one by one by sequentially performing the processes in the production facilities 11 to 14 corresponding to the first to fourth processes.

The production facilities 11 to 14 are provided with the PLCs 21 to 24, respectively. Each of the PLCs 21 to 24 is a known control device called a programmable logic controller, and is configured to control a respective one of the production facilities 11 to 14 by executing a respective ladder program. The PLCs 21 to 24 output log data of the production facilities 11 to 14 to the communication server 30. The log data is output when a predetermined event occurs in the PLCs 21 to 24, and includes an “occurrence time”, a “facility ID”, and an “event ID”. Details of the log data will be described later.

The communication server 30 is configured to receive log data from the PLCs 21 to 24 and to transmit the received log data to a host system. Specifically, the communication server 30 is an OPC-UA server. OPC-UA, an Object Linking and Embedding for Process Control-Unified Architecture, is a standard for interoperability for safe and reliable data exchange in an industrial automation field and other industries.

A plurality of PLC connection drivers of various manufactures are installed on the communication server 30 so as to drive PLCs, and the communication server 30 can send the log data output from each PLC to the host system (the collection and storage device 34 in the present embodiment). Therefore the communication server 30 can send the log data to the host system even if the plurality of PLCs 21 to 24 are products of different manufacturers. The communication server 30 collects log data from the PLCs 21 to 24 based on collection and storage information set by a collection and storage setting application 32.

FIG. 2 shows an example of the log data received by the communication server 30. Here, the “occurrence time” is information indicating a time at which a predetermined event has occurred, and includes date information. The “occurrence time” includes, for example, a time when an abnormality has occurred in the production facilities 11 to 14, start and end times of the cycle time, start and end times of an operation stop, and the like. The “facility ID” is information for identifying the production facilities 11 to 14 in which the event has occurred, and a correspondence between the facility IDs and each of the production facilities 11 to 14 is defined by a separately provided table. The “event ID” is information for identifying a content of the event, and a correspondence between the event ID and the content of the event is defined by a separately provided table. Such events that are subject to be output as the log data are, for example, occurrence of an abnormality, a start and an end of the cycle time, a start and an end of an operation stop state, or a change of a product number. When the event ID represents “an occurrence of an abnormality”, the event ID includes information indicating a content of an abnormality that has occurred and also information for distinguishing/identifying a facility abnormality related to a production facility and a quality abnormality related to a quality of a product, and the like.

The collection and storage device 34 is a computer (a database server) configured to collect data from the communication server 30 and to store the data in the database group 40. A collection and storage application 35 is installed in the collection and storage device 34. Based on collection and storage information set by the collection and storage setting application 32, the collection and storage device 34 stores predetermined data in the first database 42 of the database group 40 based on the log data from the PLCs 21 to 24 collected by the communication server 30.

The database group 40 is a database configured to store various types of data for factory management, and includes a first database 42 and a second database 44 that are connected to the Internet INT. The first database 42 is a storage device configured to store production status data collected by the collection and storage device 34 via the communication server 30 based on the log data output from the PLCs 21 to 24. In the first database 42, a time-specific table 42a, a stop time count table 42b, and an abnormality history table 42c are stored as the production status data.

The time-specific table 42a is a data table that stores the number of products manufactured in each period of time in the production line 10 for each product number. The collection and storage device 34 counts up the number of productions each time log data indicating the end of the cycle time is received from the PLC 24, which is in the final process (the fourth process inspection machine in the present embodiment) of the production line 10, and updates the time-specific table 42a. FIG. 3 shows a storage example of the time-specific table 42a in the production line 10. The storage example of the time-specific table 42a shown in FIG. 3 indicates that, during the period of time from 10:00 to 11:00 on Sep. 27, 2019, 10 products of No. 1, 110 products of No. 2, and 15 products of No. 3 were produced.

The stop time count table 42b is a data table that stores a history of time when the production line 10 (the production facilities 11 to 14) has stopped operating. The collection and storage device 34 updates the time-specific table each time log data of a start and an end of stop time is received from the PLCs 21 to 24. FIG. 4 shows a storage example of the stop time count table 42b in the first process machine of the production facility 11. As shown in FIG. 4, the stop time count table 42b stores the number of times for which stop time occurs, a start time of a stop, an end time of a stop, and the number of seconds of the stop time. The storage example of the stop time count table 42b shown in FIG. 4 indicates that a start time of first stop time is 10:06:35 on Sep. 27, 2019, an end time of a stop is 10:06:56 on Sep. 27, 2019, and the number of seconds of the stop time is 21.

The abnormality history table 42c is a data table that stores an abnormality history having occurred in the production line 10 (the production facilities 11 to 14). The collection and storage device 34 updates the abnormality history table 42c each time log data indicating an occurrence of an abnormality is received from the PLCs 21 to 24. FIG. 5 shows a storage example of the abnormality history table 42c in the second process machine of the production facility 12, and shows an occurrence time of an abnormality, a content of the abnormality, and an abnormality type (a quality abnormality or a facility abnormality). The abnormality history table 42c shown in FIG. 5 indicates that the occurrence time of an abnormality is 11:47:15 on Sep. 26, 2019, the content of the abnormality is a dimension defect, and the abnormality type is the quality abnormality.

The second database 44 is a storage device in which factory status data is stored by data input executed by an administrator of the production line 10 in a factory. The second database 44 is connected to the input and storage device 36 via a communication network.

The input and storage device 36 includes an input unit such as a keyboard and a mouse and a display unit such as a display, and is a personal computer or the like connected to the internet INT. In the computer that is the input and storage device 36, an input and storage application 38 is installed as an application program for storing data in the second database 44. The second database 44 stores, as factory management data, an industrial accident management table 44a, a traffic accident management table 44b, a quality problem management table 44c, a change management table 44d, and a staffing management table 44e.

The industrial accident management table 44a is a data table that stores the number of industrial accidents occurring in the production line 10. The traffic accident management table 44b is a data table that stores the number of traffic accidents. The input and storage device 36 executes the input and storage application 38 to input data in the industrial accident management table 44a and the traffic accident management table 44b at an industrial accident/traffic accident input screen 38a shown in FIG. 6. Specifically, at the industrial accident/traffic accident input screen 38a, a production line and a date that are to be input are selected, the number of industrial accidents and the number of traffic accidents are input, and then a registration button (“REGISTER” button) is clicked to complete the input. The number of industrial accidents and the number of traffic accidents are input, for example, every morning by the administrator of the production line 10 in the input and storage device 36 for a previous day.

FIG. 7 shows a storage example of the industrial accident management table 44a in a first production line in an XX factory of XXX Co., Ltd. The industrial accident management table 44a stores a date and the number of industrial accidents. The storage example of the industrial accident management table 44a shown in FIG. 7 indicates that the number of industrial accidents on Sep. 20, 2019 is 1 and the like. FIG. 8 also shows a storage example of the traffic accident management table 44b. The traffic accident management table 44b stores a date and the number of traffic accidents. The storage example of the traffic accident management table 44b shown in FIG. 8 indicates that the number of traffic accidents on Sep. 25, 2019 is 1 and the like.

The quality problem management table 44c is a data table that stores the number of quality problems in the production line 10. The input and storage device 36 executes the input and storage application 38 to input data in the quality problem management table 44c at a quality problem input screen 38c shown in FIG. 9. Specifically, at the quality problem input screen 38c, after a production line, a date, and a serial number (No.), which are serially to be allocated to each of quality problems that have occurred on the same day, are to be input are selected, text describing a content of a quality problem is input in a contact form and a registration button is clicked to complete the input. For an important quality problem, a check is input in a square check box that is adjacent to a right of a description “important”. A quality problem is input, for example, by an administrator of a production line at any time when the quality problem becomes known. FIG. 10 shows a storage example of the quality problem management table 44c in the first production line in the XX factory of XXX Co., Ltd. The quality problem management table 44c stores a date, a serial number (No.) of the same day, an input content in a contact form, and classification of whether a quality problem is an important one.

The change management table 44d is a data table for managing 4M changes in the production line 10. The input and storage device 36 executes the input and storage application 38 to input data in the change management table 44d on a 4M change input screen 38d shown in FIG. 11. Specifically, on the 4M change input screen 38d, after a production line and a date that are to be input are selected, a type of 4M, a type of change, whether it is a planned one or an unexpected one, a date and time of an occurrence, a change content, a stage of process, and a product number are input and a registration button is clicked to complete the input.

Here, “4M” stands for four-item management elements that have an English initial M and are important in producing an object. Specifically, “4M” refers to a man, a machine, a method, and a material. That is, a “4M change” means change information when there is a plan to change some items of 4M (a man, a machine, a method, and a material) or when a change occurs unexpectedly. Each item of the 4M change is input by an administrator of a production line at any time using the input and storage device 36.

FIG. 12 shows a storage example of the change management table 44d in the first production line in the XX factory of XXX Co., Ltd. The change management table 44d stores a type of the 4M change, that are a man, a machine, a method, or a material, a planned change or an unexpected change, a date and time of an occurrence, a change content, a stage of process, and a product number.

For example, when the type of 4M is a “man”, as the change content, a “change due to illness”, which is “unexpected”, “rotation”, which is “planned”, or the like is stored. When the type of 4M is a “method”, a “change of machining and assembly method”, which is “planned”, or the like is stored as the change content. When the type of 4M is a “machine”, a “planned repair”, which is “planned”, an “emergency repair”, which is “unexpected”, or the like is stored as the change content. When the type of 4M is a “material”, a “design change”, which is “planned”, or the like is stored as the change content. By storing the 4M change in the second database 44 in this way, it is possible to improve traceability of a product.

The staffing management table 44e is a data table for managing information on staffing of operators in the production line 10. The input and storage device 36 executes the input and storage application 38 to input data in the staffing management table 44e at a staffing input screen 36e shown in FIG. 13. Specifically, at the staffing input screen 38e, after a production line, a date, and a stage of process that are to be input are selected, an operator name is selected from a candidate list and a registration button is clicked to complete the input. FIG. 14 shows a storage example of the staffing management table 44e on Sep. 26, 2019 in the first production line in the XX factory of XXX Co., Ltd. The storage example of the staffing management table 44e shown in FIG. 14 stores an operator name “Ichiro Sato” in the first process, an operator name “Hanako Tanaka” in the second process, and the like.

The compilation and display device 50 is a computer that includes a display configured to display a screen and is connected to the Internet INT. The Internet INT corresponds to a communication interface according to the present invention. The compilation and display device 50 is configured to acquire necessary data from the database group 40, to compile the data, and to display the data in a form of a predetermined website on the display. In addition to a normal desktop PC or a notebook PC, for example, a touch panel type computer including a touch panel that doubles as an input unit and a display unit can be preferably used as the compilation and display device 50. Three types of compilation and display applications, which are a compilation and display application 52, a compilation and display application 54, and a compilation and display application 56, are installed in the compilation and display device 50.

The compilation and display application 52 is used for displaying a factory management home screen 53 shown in FIG. 15. The compilation and display application 54 is used for displaying a production record management screen 55 shown in FIG. 18. The compilation and display application 56 is used for displaying a screen for compiled data on abnormality 57 shown in FIG. 20. Details of the factory management home screen 53, the production record management screen 55, and the screen for compiled data on abnormality 57 will be described later.

The compilation and display device 50 is configured to compile various types of data stored in the database group 40 and to display the factory management home screen 53 by executing the compilation and display application 52. FIG. 15 shows a display example of the factory management home screen 53. The factory management home screen 53 is displayed on, for example, a large-sized liquid crystal display provided in a factory so that an administrator, an operator, and the like of a production line that perform operation in the factory can see the factory management home screen 53.

As shown in FIG. 15, the factory management home screen 53 includes a display selection part 53a, a daily management display part 53b, a change management display part 53c, a staffing display part 53d, and a production status display part 53e.

The display selection part 53a is a region at a top of the factory management home screen 53 and is used for selecting a display target. Items of factory management information which are a date, a company name, a factory name, and a production line name are displayed. In the display example of the factory management home screen 53 shown in FIG. 15, the date is displayed as “2019-09-27”, the company name is displayed as “XXX Co., Ltd.”, the factory name is displayed as “XX factory”, and the production line name is displayed as “first production line”. When one of a plurality of candidates displayed in a pull-down menu of each item is selected in the display selection part 53a, factory management information corresponding to the selected date, company, factory, and production line can be read from the first database 42 or the second database 44 of the database group 40 and can be displayed on the daily management display part 53b to the production status display part 53e.

The daily management display part 53b is provided at an upper part of the factory management home screen 53 and below the display selection part 53a, and includes a safety management display part 53b1 and a quality management display part 53b2. The safety management display part 53b1 displays occurrence status of an industrial accident and a traffic accident by compiling data out of the industrial accident management table 44a and the traffic accident management table 44b that are stored in the second database 44.

In an industrial accident display region that occupies a left half of the safety management display part 53b1, a calendar showing the numbers 1 to 30 indicating dates of a present month is arranged in a cross shape. For a previous day and days before the previous day, days on which no accident has occurred are displayed in green (shown by diagonal lines rising to a right in FIG. 15), and days on which an accident has occurred are displayed in pink (shown by diagonal lines descending to the right in FIG. 15). A present day (today) and days after the present day are displayed in white. Since a traffic accident display region that occupies a right half of the safety management display part 53b1 is similar to the industrial accident display region in that a cross-shaped calendar is displayed and whether an accident has occurred is displayed in different colors, a detailed description of the traffic accident display region is omitted.

The quality management display part 53b2 displays a quality problem occurrence status of a present month by compiling data out of the quality problem management table 44c stored in the second database 44. Specifically, the quality management display part 53b2 displays the number of occurrences of important quality problems and the number of occurrences of the quality defects together with the increase or decrease number thereof with respect to a previous month. Further, a calendar for the present month is displayed. For the previous day and days before the previous day, days on which no important quality problem has been registered are displayed in green (shown by diagonal lines rising to the right in FIG. 15), and days on which an important quality problem has been registered are displayed in pink (shown by diagonal lines descending to the right in FIG. 15). For the present day and days after the present day, a frame of a date is displayed in white.

The change management display part 53c displays change management information of a present day by compiling data out of the change management table 44d stored in the second database 44. Specifically, the change management display part 53c displays the number of planned changes and the number of unexpected changes of the 4M changes in a switchable manner with tabs, and displays specific contents of each change.

The staffing display part 53d displays staffing information of a present day by compiling data from the staffing management table 44e stored in the second database 44. Specifically, the staffing display part 53d displays the number of persons on the present day in the production line 10, and displays a name list of all the persons working on the present day. In the display example shown in FIG. 15, the number of persons today is displayed as 31, and names of the persons are displayed in a list.

The production status display part 53e displays a production status by compiling data from the time-specific table 42a, the stop time count table 42b, and the abnormality history table 42c that are stored in the first database 42. Specifically, the production status display part 53e displays % values of an operation ratio and a first time through ratio, and an overall Pareto diagram 53f displays the number of abnormalities in units of facility.

The operation ratio means “a rate of time during which a facility has normally operated when the facility is desired to be operated”. Based on the data compiled from the database group 40, the operation ratio is calculated by the compilation and display application 52 using the following formula (Formula (1)). Formula (1): Operation ratio (the number of actually produced products×standard cycle time/actual production time)×100[%] (i.e. OR [%]=(N*CT/PT)*100, in which OR is the operation ratio, N is a number of actually produced products, CT is standard cycle time, and PT is actual production time). As the standard cycle time and the actual production time, data that is set on the production record management screen 55 using the compilation and display application 54 (described later) and is stored in the second database 44 is used. In the display example of the production status display part 53e shown in FIG. 15, the operation ratio is displayed as 92.5[%].

The first time through ratio means a ratio of the number of products which have been smoothly produced from a first process to a final process to the number of actually produced products, the smoothly produced products having been produced without repairs and adjustments (retries) due to defective operation or the like, without stagnation in the production line due to defective components or missing components, and without being taken out of the production line (discarded). Based on the data compiled from the database group 40, the first time through ratio is calculated by the compilation and display application 52 using the following formula (Formula (2)). Formula (2): First time through ratio=(1−the number of retries and discarded products/the number of actually produced products)×100[%] (i.e. FTR [%]=(1−NRD/N)*100, in which FTR is the first time through ratio, NRD is a number of retries and disposed products, and N is the number of actually produced products). As the number of retries and discarded products, data that is set on the production record management screen 55 using the compilation and display application 54 (described later) and is stored in the second database 44 is used. In the display example of the production status display part 53e shown in FIG. 15, the first time through ratio is displayed as 98.8[%].

The overall Pareto diagram 53f showing the number of abnormalities in each production facility displays the number of abnormalities in the entire production line 10 in a predetermined period by a bar graph in units of production facility. A vertical axis shows the number of abnormalities, and bar graphs are displayed in descending order from left to right for each production facility. A lower diagram of FIG. 16 is an enlarged view of the overall Pareto diagram 53f showing the number of abnormalities in each production facility in the entire production line 10. In the example of the overall Pareto diagram 53f shown in the lower diagram of FIG. 16, since the number of abnormalities in the second process machine, which is the production facility 12, is the largest, a bar graph is displayed on the far let. Next, bar graphs of the production facility 14 (the fourth process inspection machine), the production facility 11 (the first process machine), and the production facility 13 (the third process assembly machine) are displayed in descending order. In each bar graph, the number of quality abnormalities and the number of facility abnormalities are displayed separately, respectively in white (an upper part of the bar graph) and by being shaded (a lower part of the bar graph), so that a ratio of the number of quality abnormalities and the number of facility abnormalities can be visually grasped. With reference to the overall Pareto diagram 53f, it is possible to visually and easily grasp a production facility having a large number of abnormalities in the production line 10, so that it is possible to prioritize the production facilities and to efficiently carry out a repairing treatment or the like.

In the overall Pareto diagram 53f (the lower diagram of FIG. 16), when a white region of any of the bar graphs of the production facilities 11 to 14 is clicked, another window is opened, and a breakdown of the quality abnormalities in the production facility is displayed in a graph. Hereinafter, a graph in which a part of the overall Pareto diagram 53f is detailed is referred to as an individual Pareto diagram. In an individual Pareto diagram 53g (an upper left diagram of FIG. 16) of the quality abnormalities, the numbers of abnormalities each for a respective abnormality content are shown in descending order from left to right. Examples of the abnormality content regarding quality include a “cutting failure”, a “polishing failure”, a “dimension defect”, an “angle defect”, an “appearance defect”, and a “tightening failure”. In a window shown in the upper left diagram of FIG. 16, bar graphs showing the number of abnormalities for each abnormality content are displayed in order of the “cutting failure”, the “polishing failure”, and the “dimension defect” in descending order from left to right regarding the quality abnormalities occurring in the second process machine which is the production facility 12.

When a shaded region of any of the bar graphs of the production facilities 11 to 14 is clicked, yet another window is opened, and a breakdown of the facility abnormalities in the production facility is displayed in a graph. In an individual Pareto diagram 53h (an upper right diagram of FIG. 16) of the facility abnormalities, the numbers of abnormalities each for a respective abnormality content are shown in descending order from left to right. Examples of the facility abnormality content include a “tool breakage”, a “material shortage”, a “drive system failure”, “chip clogging”, a “position sensor failure”, and a “temperature sensor failure”. In a window shown in the upper right diagram of FIG. 16, bar graphs showing the number of abnormalities for each abnormality content are displayed in order of the “tool breakage”, the “material shortage”, and the “drive system failure” in descending order from left to right regarding the facility abnormalities occurring in the second process machine which is the production facility 12.

Further, In the overall Pareto diagram 53f (the lower diagram of FIG. 16), when any production facility name (for example, the second process machine) is clicked, as shown in FIG. 17, still another window is opened, and a fluctuation of cycle time in the production facility is displayed in a graph. Hereinafter, the graph is referred to as a cycle time graph 53i. The cycle time graph 53i shown in FIG. 17 is generated and displayed based on a cycle time data table (not shown) of each production facility stored in the first database 42, and displays a history of the fluctuation of the cycle time using cycle time of each cycle as a vertical axis and using cumulative time from a start of operation of the production facility as a horizontal axis.

In the cycle time graph 53i, further, with reference to the abnormality history table 42c, dots 53j to 53l indicating abnormality occurrence time points are plotted and displayed in the cycle time graph 53i. Vertical axis positions of the dots 53j to 531 represent stop time (the number of seconds of error stop time) associated with an occurrence of an error. Each of the production facilities 11 to 14 is provided with a camera, and a video is captured. When any one of the dots 53j to 53l indicating an occurrence of an abnormality displayed on the cycle time graph 53i is clicked and selected, another window is opened as shown in upper right of FIG. 17, a video 53m, which is obtained by capturing a video of a state of the production facility from a predetermined time (approximately ten and several seconds) before the occurrence of an abnormality selected by the dot corresponding thereto for a predetermined time (approximately ten and several seconds to several tens of seconds) after the occurrence, is reproduced and displayed.

The compilation and display device 50 is configured to compile various types of data stored in the database group 40 and to display the production record management screen 55 by executing the compilation and display application 54. FIG. 18 shows a display example of the production record management screen 55. Similarly to the factory management home screen 53, the production record management screen 55 is displayed on a large-sized liquid crystal display provided in a factory.

As shown in FIG. 18, the production record management screen 55 includes a line name selection part 55a, a display setting part 55b, a cycle time setting part 55c, an operation ratio display part 55d, a first time through ratio display part 55e, a production record display part 55f, a problem treatment display part 55g, and a production time registration part 55h.

The line name selection part 55a is a region in which a name of a production line is selected. A production record management table is displayed for the selected production line. The display example in FIG. 18 shows an example in which the “first production line” is selected as the production line. The display setting part 55b is a region in which a date is set. The production record management table is displayed on the set date. The display example in FIG. 18 shows an example in which “2019-09-27” (Sep. 27, 2019) is selected as the date. The cycle time setting part 55c is a region in which standard cycle time in the selected production line is input and set. In the display example in FIG. 18, the standard cycle time is set as “30.0” seconds.

The operation ratio display part 55d is a region in which a present operation ratio in the selected production line is displayed. A value of the operation ratio is calculated using the compilation and display application 54 and the following formula. Operation ratio=(the number of actually produced products×standard cycle time/actual production time)×100[%]. In the display example in FIG. 18, the operation ratio is “92.5”%. Meanwhile, the first time through ratio display part 55e is a region in which a present first time through ratio in the selected production line is displayed. A value of the first time through ratio is calculated using the compilation and display application 54 and the following formula. First time through ratio=(1−the number of retries and discarded products/the number of actually produced products)×100[%]. In the display example in FIG. 18, the first time through ratio is “98.8”%.

The production record display part 55f is a region in which a production record table obtained by compiling data in the time-specific table 42a in the first database 42 is displayed. The production record table shows a period of time, a target number (of production), product numbers, and a cumulative record (of production). In the display example in FIG. 18, the production target number at 10 o'clock is 150. The number of products of No. 1 produced is 10, the number of products of No. 2 produced is 110, and the number of products of No. 3 produced is 15, which are a total number of production, 135. A cumulative number up to the period of time is 280, and the like.

The problem treatment display part 55g is a region in which the number of occurrences of problems for each period of time, the number of treatments, each total, and a graph for each period of time are displayed. A total value of the number of treatments is used as the number of retries and discarded products to calculate the first time through ratio and the like. In the display example in FIG. 18, the number of occurrences of problems at 9 o'clock is five, the number of treatments done is one, and the like. Further, bar graphs show a transition of the number of occurrences of problems for each period of time. When a bar graph is clicked, another window is opened, and a problem and abnormality treatment detail screen 55g1 is displayed. As shown in FIG. 19, the problem and abnormality treatment detail screen 55g1 displays items such as an occurrence time of a problem, a facility name where the problem has occurred, a product number about which the problem has occurred, an abnormality content, and a treatment content. In the display example in FIG. 19, about a problem, the occurrence time is 10:13:38, the facility name is the fourth process inspection machine, the product number is 4, the abnormality content is “impossible to recover”, treatment is disposal, and the like.

The production time registration part 55h is a region in which actual production time is calculated and registered, and includes input frames in which regular operation time, overtime time, maintenance time, and other time are input, a display frame in which a calculation result of the actual production time is displayed, and a registration button. By inputting each of the constant time operation time, the overtime time, the maintenance time, and other time into a respective one of the input frames, the actual production time is automatically calculated by regular operation time+overtime time−maintenance time and other time and is displayed in the display frame. By clicking the registration button while the actual production time is displayed on the display frame, the actual production time is registered in the second database 44.

The compilation and display device 50 is configured to compile various types of data stored in the database group 40 and to display the screen for compiled data on abnormality 57 on the display by executing the compilation and display application 56. FIG. 20 shows a display example of the screen for compiled data on abnormality 57.

As shown in FIG. 20, the screen for compiled data on abnormality 57 includes a line name selection part 57a, a display setting part 57b, a search target setting part 57c, a search button 57d, a CSV button 57e, an abnormality compilation table 57f, a facility-specific graph 57g, and a date-specific graph 57h. The line name selecting part 57a is a region in which a name of a production line is selected. A screen for compiled data on abnormality is displayed for the selected production line. The display example in FIG. 20 shows an example in which the “first production line” is selected. The display setting part 57b is a region in which a year and a month are set. The screen for compiled data on abnormality is displayed for the year and the month. The display example in FIG. 20 shows an example in which “September 2019” is selected.

The search target setting part 57c is a region in which a search target is set and a type of abnormality, a type of treatment, and a type of work shift can be selected. As for the type of abnormality, “facility” can be selected when only facility abnormalities are to be displayed, “quality” can be selected when only quality abnormalities are to be displayed, and “all” can be selected when all including the facility abnormalities and the quality abnormalities are to be displayed. As for the type of treatment, “retry” can be selected when only retries are to be displayed, “discarded product” can be selected when only discarded products are to be displayed, and “all” can be selected when all including the retries and the discarded products are to be displayed. As for the type of work shift operation, “operation by Team A” can be selected when only the operation by Team A is to be displayed, “operation by Team B” can be selected when only the operation by Team B is to be displayed, and “all” can be selected when all including the operation by Team A and the operation by Team B are to be displayed.

After the search target is set in the search target setting part 57c, the search button 57d is clicked to display the abnormality compilation table 57f in which abnormalities of the search targets are compiled. By clicking the CSV button 57e, a CSV file in which the abnormalities of the search targets are compiled is output.

The abnormality compilation table 57f is a compilation table in which the number of abnormalities corresponding to the search targets set in the line name selection part 57a, the display setting part 57b, and the search target setting part 57c is compiled. The abnormality compilation table 57f includes items of a facility name, an abnormality name, and dates of one month (target month), and displays the number of abnormalities per day for the one month for each abnormality name of each facility. The display example in FIG. 20 shows that a door opening and closing abnormality of a facility B has occurred at 2nd, 9th, and 25th in a target month.

The facility-specific graph 57g is a pie chart that displays the number of abnormalities of each facility during one month, and is displayed below a facility name column and an abnormality name column of the abnormality compilation table 57f. When a region of each facility is clicked and selected in the facility-specific graph 57g, another window is opened, and an breakdown graph for abnormality 57g, which is a pie chart indicating a breakdown of an abnormal content of the selected facility, is displayed. FIG. 21 shows a display example of an breakdown graph for abnormality when one facility has been selected. The date-specific graph 57h is a bar graph that displays the number of abnormalities by date for one month in all facilities, and is displayed below each date of the abnormality compilation table 57f.

As described above, according to the factory management system 1 in the present embodiment, production status data is collected from each of the production facilities 11 to 14 via the communication server 30 which is the communication unit, and is reliably stored in the first database 42 of the database group 40 by the collection and storage device 34 in which the collection and storage application 35 is installed as the collection and storage unit. Meanwhile, by the compilation and display device 50 in which the compilation and display applications 52, 54, 56 installed separately from the collection and storage application 35 via the Internet INT are installed, any piece of data out of the production status data stored in the first database 42 according to a desired purpose, is compiled and is displayed in various forms (the factory management home screen 53, the production record management screen 55, and the screen for compiled data on abnormality 57). The compilation and display applications 52, 54, 56 are used as the compilation and display unit, the collection and storage application 35 is used as the collection and storage unit, and the Internet INT is used as the communication interface. Therefore, the data output from the production facilities 11 to 14 can be commonly used to execute various types of display according to various purposes.

Further, with a configuration in which the collection and storage application 35 used as the collection and storage unit, the compilation and display application 52 used as the compilation and display unit, and the like are separated, the following product development advantages can be considered. That is, since knowledge about production facilities is required for development of the collection and storage application 35, a production facility manufacturer who is familiar with the production facility can efficiently develop the high-performance collection and storage application 35. Meanwhile, since knowledge of data processing and display processing is required for development of the compilation and display application 52 and the like, a software vendor having high data processing and display processing skills can efficiently develop the high-performance compilation and display application 52 and the like. Therefore, the configuration according to the present embodiment has an advantage of facilitating efficient development of a high-performance and high-quality system.

The collection and storage application 35 collects, as the production status data, production quantity data indicating the number of actually produced products and stores the production quantity data in the first database 42 (the time-specific table 42a). The compilation and display application 54 compiles, as the production status data, the production quantity data stored in the first database 42 and displays the production quantity data (on the factory management home screen 53 and the production record management screen 55). Therefore, an administrator of a factory or the like can quickly and reliably grasp a production record of a product.

The collection and storage application 35 collects, as the production status data, abnormality occurrence number data indicating the number of abnormality occurrences relating to a product quality and the production facility, and stores the abnormality occurrence number data in the first database 42 (the abnormality history table 42c). The compilation and display applications 52 to 56 compile, as the production status data, the abnormality occurrence number data from the first database 42 and display the abnormality occurrence number data (on the factory management home screen 53, the production record management screen 55, and the screen for compiled data on abnormality 57). Therefore, an administrator of a factory or the like can quickly and reliably grasp the product quality and an occurrence status of an abnormality in the production facility.

The factory management system 1 further includes the input and storage application 38 as the input and storage unit that inputs in-factory status data relating to a status in a factory and stores the in-factory status data in the second database 44. The compilation and display applications 52, 54, 56 compile any piece of data out of the production status data stored in the first database 42 and the in-factory status data stored in the second database 44 in the database group 40 and display the data (on the factory management home screen 53, the production record management screen 55, and the screen for compiled data on abnormality 57). According to this configuration, the production status data and the in-factory status data that are from different data sources can be compiled according to desired purposes and can be displayed in various forms. Accordingly, an administrator of a factory or the like can accurately grasp a production status and an in-factory status, and further analyze relation.

The compilation and display applications 52, 54, 56 display a display based on the production status data and a display based on the in-factory status data on the same screen (the factory management home screen 53, the production record management screen 55, and the screen for compiled data on abnormality 57). For example, in the factory management home screen 53, the production status display part 53e based on the production status data, the daily management display part 53b, the change management display part 53c, and the staffing display part 53d that are based on the in-factory status data are displayed on the same screen. According to this configuration, an administrator of a factory or the like can quickly grasp a production status and an in-factory status on the same screen, and further efficiently analyze the relation.

The input and storage application 38 inputs, at the industrial accident/traffic accident input screen 38a, industrial accident data relating to an industrial accident occurrence status in a factory and traffic accident data relating to a traffic accident occurrence status of operators in the factory as the in-factory status data, and stores the industrial accident data and the traffic accident data in the second database 44 (the industrial accident management table 44a and the traffic accident management table 44b). The compilation and display application 52 compiles, as the in-factory status data, the industrial accident data and the traffic accident data stored in the second database 44, and displays the industrial accident data and the traffic accident data (on the factory management home screen 53). According to this configuration, an administrator of a factory or the like can accurately grasp an occurrence status of an industrial accident and a traffic accident in the factory together with a production status.

The input and storage application 38 inputs, on the quality problem input screen 38c, quality problem occurrence status data relating to an occurrence status of a quality problem in a factory as the in-factory status data, and stores the quality problem occurrence status data in the second database 44 (the quality problem management table 44c). The compilation and display applications 52 to 56 compile, as the in-factory status data, the quality problem occurrence status data stored in the second database 44, and display the quality problem occurrence status data (on the factory management home screen 53, the production record management screen 55, and the screen for compiled data on abnormality 57). According to this configuration, an administrator of a factory or the like can accurately grasp an occurrence status of a quality problem in the factory together with a production status.

The input and storage application 38 inputs, on the 4M change input screen 38d, 4M change management data relating to changes of a man, a machine, a method, and a material, which are predetermined management elements in a factory, as the in-factory status data, and stores the 4M change management data in the second database 44 (the change management table 44d). The compilation and display application 52 compiles the 4M change management data stored in the second database 44 as the in-factory status data, and displays the 4M change management data (on the factory management home screen 53). According to this configuration, an administrator of a factory or the like can accurately grasp a status of the 4M change, which is an important management element, together with a production status.

The input and storage application 38 inputs, at the staffing input screen 38e, staffing data relating to a staffing status of operators in the production line 10 as the in-factory status data, and stores the staffing data in the second database 44 (the staffing management table 44e). The compilation and display application 52 compiles the staffing data stored in the second database 44 as the in-factory status data, and displays the staffing data (on the factory management home screen 53). According to this configuration, an administrator of a factory or the like can accurately grasp a staffing status together with a production status.

The compilation and display applications 52, 54, 56 execute predetermined calculation processing using both the production status data and the in-factory status data that are compiled stored in the first database 42 and the second database 44, and execute predetermined display based on a result of the predetermined calculation processing. According to this configuration, it is possible to derive and display a result that cannot be obtained separately from independent data of the production status data and the in-factory status data, which can be useful for factory management.

Specifically, the collection and storage application 35 collects, as the production status data, production quantity data indicating the number of actually produced products in the first database 42 (the time-specific table 42a). The input and storage application 38 inputs, as the in-factory status data, standard cycle time data relating to standard cycle time of the production line and actual production time data relating to actual production time, and stores the standard cycle time data and the actual production time data in the second database 44. The compilation and display applications 52, 54 collect the production quantity data from the first database 42 and the standard cycle time data and the actual production time data from the second database 44, calculate the operation ratio using the following formula, and display the operation ratio (on the factory management home screen 53 and the production record management screen 55). Operation ratio [%]=(the number of actually produced products×standard cycle time/actual production time)×100. According to this configuration, an administrator of a factory or the like can grasp a degree to which a facility normally operates by looking at a displayed operation ratio.

The collection and storage application 35 collects, as the production status data, production quantity data indicating the number of actually produced products, and stores the production quantity data in the first database 42 (the time-specific table 42a). The input and storage application 38 inputs, as the in-factory status data, the number data of retries and discarded products, the number data indicating the number of products which underwent a retry or have been discarded, and stores the number data of retries and discarded products in the second database 44. The compilation and display applications 52, 54 collect the production quantity data from the first database 42 and the number data of retries and discarded products from the second database 44, calculate the first time through ratio using the following formula, and display the first time through ratio (on the factory management home screen 53 and the production record management screen 55). First time through ratio [%]=(1−the number of retries and discarded products/the number of actually produced products)×100. According to this configuration, an administrator of a factory or the like can grasp a degree to which a product flows through the production line without stagnation by looking at a displayed first time through ratio.

The communication server 30 used as the communication unit adopts the OPC-UA standard, and is configured to communicably connect the PLCs 21 to 24 provided in the production facilities 11 to 14 with the collection and storage device 34. According to this configuration, even if standards adopted by the PLCs 21 to 24 are different due to such circumstances as that the PLCs are produced by different manufacturers and the like, the communication server 30 can reliably receive log data according to the OPC-UA standard which is a standard communication standard, and can send the log data to a host system, such as the collection and storage device 34. The collection and storage device 34 can collect the data.

The compilation and display applications 52, 54, 56 display the compiled data on a website 60. According to this configuration, in an environment in which connection to the Internet is possible, it is possible to display information on factory management including a production status by accessing the website in a state in which security is ensured.

The present invention is not limited to the above-described embodiment, and various modifications can be made without departing from the gist of the present invention. The screen display according to the above-described embodiment is an example, and any changes can be made. For example, contents and arrangement of the display regions of the factory management home screen 53, the production record management screen 55, and the screen for compiled data on abnormality 57 can be changed as necessary.

The above-described embodiment shows an example in which the database group 40 includes two physically different database devices which are the first database 42 and the second database 44. However, a single database device may be used to store the production status data and the in-factory status data in the single database device.

In the above-described embodiment, a case has been described as an example in which one compilation and display device 50 is provided. However, two or more compilation and display devices 50 connected to the internet may be provided. Similarly, a case has been described as an example in which the number of the compilation and display applications 52 and the like is three. However, the number of the compilation and display applications 52 and the like may be less than or more than three.

In the above-described embodiment, the collection and storage application 35 collects and stores, as the abnormality occurrence number data, the number of occurrences of both an abnormality of a product quality and an abnormality in a production facility. However, the collection and storage application 35 may collect and store the number of occurrences of any one of the abnormalities. The input and storage application 38 inputs and stores both the industrial accident data and the traffic accident data. However, the input and storage application 38 may input and store either one of the industrial accident data and the traffic accident data.

The input and storage application 38 may provide a bulletin board input screen in which any information, such as message to a certain person, or the like, can be input, in addition to the input screens according to the above-described embodiments, and may store contents input at the bulletin board input screen in the second database 44. The compilation and display application may compile the contents and may display the contents on a bulletin board. According to this configuration, since the contents on the bulletin board are displayed by accessing a website of the bulletin board, it is possible to smoothly communicate the messages or the like to be seen/conveyed regardless of a place.

What is claimed is:

1. A factory management system having a database for managing a factory in which a production line is provided, the factory management system comprising:
a communication unit configured to connect each of production facilities of the production line with host systems such that the production facilities and the host systems communicate with each other;
a collection and storage unit being one of the host systems, the collection and storage unit being configured to:
collect production status data relating to a production status from each of the production facilities via the communication unit; and
store the production status data in the database; and
a compilation and display unit provided separately from the collection and storage unit via a communication interface, the compilation and display unit configured to:
compile a first predetermined data out of the production status data stored in the database; and
display the first predetermined data.

2. The factory management system according to claim 1,
wherein the production status data is production quantity data indicating a number of actually produced products, and
wherein the first predetermined data is the production quantity data.

3. The factory management system according to claim 1,
wherein the production status data is abnormality occurrence number data indicating a number of abnormality occurrences relating to at least one of quality of the products and the production facility, and
wherein the first predetermined data is the abnormality occurrence number data.

4. The factory management system according to claim 1, further comprising:
an input and storage unit configured to receive an input of in-factory status data relating to a status in the factory and to store the in-factory status data in the database,
wherein the compilation and display unit is configured to compile and display a second predetermined data out of the production status data and the in-factory status data stored in the database.

5. The factory management system according to claim 4,
wherein the compilation and display unit is configured to display a display content based on the production status data and a display content based on the in-factory status data on the same screen.

6. The factory management system according to claim 4,
wherein the in-factory status data is at least one of industrial accident data relating to an industrial accident occurrence status in the factory and traffic accident data relating to a traffic accident occurrence status of operators in the factory, and
wherein the second predetermined data is the at least one of the industrial accident data and the traffic accident data.

7. The factory management system according to claim 4,
wherein the in-factory status data is quality problem occurrence status data relating to an occurrence status of a quality problem in the factory, and
wherein the second predetermined data is the quality problem occurrence status data.

8. The factory management system according to claim 4,
wherein the in-factory status data is change management data relating to changes of predetermined management elements in the factory, and
wherein the second predetermined data is the change management data.

9. The factory management system according to claim 8,
wherein the change management data is 4M change management data relating to changes of man, machine, method and material.

10. The factory management system according to claim 4,
wherein the in-factory status data is staffing data relating to a staffing status of operators in the production line, and
wherein the second predetermined data is the staffing data.

11. The factory management system according to claim 4,
wherein the compilation and display unit is configured to:
execute a predetermined calculation using both the production status data and the in-factory status data compiled; and
execute a predetermined display based on a result of the predetermined calculation.

12. The factory management system according to claim 11,
wherein the production status data is the production quantity data indicating a number of actually produced products,
wherein the in-factory status data is standard cycle time data relating to standard cycle time of the production line and actual production time data relating to actual production time, and
wherein the compilation and display unit is configured to:
collect the production quantity data, the standard cycle time data and the actual production time data from the database;
calculate an operation ratio by formula (1),
OR [%]=(N*CT/PT)*100, Formula (1):
wherein OR is the operation ratio, N is a number of actually produced products, CT is standard cycle time and PT is actual production time; and
display the operation ratio.

13. The factory management system according to claim 11,
wherein the production status data is the production quantity data indicating a number of actually produced products,
wherein the in-factory status data is number data of retries and disposal products related to retries or disposal of the products, and
wherein the compilation and display unit is configured to:
collect the production quantity data and the number data of retries and disposal products from the database;
calculate a first time through ratio by formula (2),
FTR [%]=(1−NRD/N)*100, Formula (2):
wherein FTR is the first time through ratio, NRD is a number of retries and disposed products, and N is the number of actually produced products; and
display the first time through ratio.

14. The factory management system according to claim 1,
wherein the communication unit is configured to connect a programmable controller provided in the production facilities with the collection and storage unit such that the programmable controller and the collection and storage unit communicate with each other.

15. The factory management system according to claim 14,
wherein the communication unit adopts an OPC-UA standard.

16. The factory management system according to claim 1,
wherein the compilation and display unit is configured to display the compiled data on a website.
